(19) United States
(12) Patent Application Publication
(10) Pub. No.: US 2010/0156070 A1
(43) Pub. Date: Jun. 24, 2010

(54) HOOD AIRBAG DEVICE FOR USE IN A VEHICLE

(76) Inventors: Hiroyuki Takahashi, Aichi-ken (JP); Takayuki Takimoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/161,060

(22) PCT Filed: Jan. 4, 2007
(86) PCT No.: PCT/IB2007/000014

§ 371 Date: Jul. 16, 2008

(30) Foreign Application Priority Data
Jan. 25, 2006 (JP) 2006-016506

(51) Int. Cl. B60R 21/20

(52) U.S. Cl. 280/728.3

(57) ABSTRACT

A vehicle hood airbag device in which a door (18) that covers an opening (22A) in the outer hood panel (22) is supported by a hinge (21) when an airbag (16) is deployed. The hinge (21) is connected to a stepped bolt (52) (a connector member) on the side of an inner hood panel (24) so that the hinge (21) is relatively displaceable within a predetermined range with respect to the inner hood panel (24). Accordingly, it is possible to accommodate the dimensional variation between the opening (22A) of the outer hood panel (22) and the door (18) when the door (18) is attached to the outer hood panel (22) to cover the opening (22A) by the relative displacement of the hinge (21) with respect to the stepped bolt (52), thereby maintaining design integrity with the external appearance of the vehicle.

### BACKGROUND OF THE INVENTION

1. Field of the Invention

The present invention relates to a hood airbag device that deploys an airbag over a hood of a vehicle.

2. Background of the Invention

A hood airbag device that includes an airbag module case fixed to an opening of a hood and a rectangular lid (door) attached to the airbag module case through an extension portion serving as a hinge is described in Japanese Patent No. JP-B2-3245489. Another airbag type occupant-protecting device in which a lid is attached in a floating state by using an engaging unit that allows the lid to be displaced within a predetermined limit with respect to an opening of an instrument panel is described in Japanese Patent Application Publication No. JP-A-7-117609.

As in the above-cited references, when an opening of an outer hood panel is covered with a door by pre-assembling (sub-assembling) an airbag module with the door attached thereto to a support member and then installing the sub-assembly on a frame member, such as an inner hood panel or the like, using bolts. The design integrity of the opening of the outer hood panel and the door may be adversely affected by both the dimensional deviation between individual components in the sub-assembling process and the positional deviation occurring when installing the sub-assembly on the frame member.

### SUMMARY OF THE INVENTION

The present invention provides a hood airbag device that maintains good design integrity of an opening in the outer hood panel and that of the door provided to cover the opening, thus improving the external appearance of the vehicle.

In accordance with an aspect of the present invention, there is provided a hood airbag device for use in a vehicle, including: an airbag disposed between an outer hood panel and an inner hood panel of a hood, the airbag adapted to be deployed through an opening of the outer hood panel by a gas supplied from an inflator; a door that covers the opening when the airbag is not deployed, the door adapted to be unfolded and opened by the force of the inflating airbag when the airbag is deployed; and a hinge connected to a connector member on the side of the inner hood panel in such a manner that the hinge is relatively displaceable within a predetermined limit with respect to the inner hood panel.

In the hood airbag device as described above, the hinge for supporting the unfolding of the door is connected to a connector member on the inner hood panel side of the hood in a floating condition so that the hinge can be relatively displaced within the predetermined limit with respect to the inner hood panel. Thus, when the door is attached to the inner hood panel to cover up the opening of the outer hood panel, the hinge can be displaced relative to the connector member and therefore can accommodate any dimensional deviation between the opening and the door. Because the door is not sub-assembled with the airbag and the inflator, there is no need to take into account the dimensional deviation in sub-assembling the airbag and the inflator. This makes it possible to maintain the design integrity of the opening of the outer hood panel and that of the door provided on the opening, thus improving the external appearance of the vehicle.

Further, it is preferred that the door is retained by a plurality of clips in a position where the door covers the opening, each of the clips being elastically deformable to be detached from the outer hood panel.

In such a hood airbag device, the door is retained by the clips in a position where the door covers the opening, each of the clips being elastically deformable so that they can be detached from the outer hood panel. Accordingly, the opening is stably covered by the door when the airbag is not deployed. In the event that the airbag is deployed and the inflating force thereof is exerted on the door, the clips are elastically deformed and separate from the outer hood panel, thereby allowing the door to unfold. Thus, it is possible to maintain the design integrity of the opening and that of the door when the airbag is not deployed. Further, when the airbag is inflated, it is possible to allow the door to be opened through the force of the inflating airbag, so that the airbag can be deployed outside the hood.

Furthermore, the relatively displaceable limit of the hinge is preferably set in such a manner as to allow the clips detached from the outer hood panel.

In this way, if the door is pushed upward by the force of the inflating airbag, the clips will detach from the outer hood panel and the door opens outward. In this regard, the clips may be detached away from the outer hood panel within the limit in which the hinge is relatively displaceable along the connector member. Thus, the presence of the hinge does not hinder the detachment of the clips, which ensures that the door unfolds in more stable manner.

Moreover, preferably, the hinge is less rigid than the door so that the hinge is plastically deformable with ease in response to the unfolding of the door. The hinge is provided with a deformable portion as a spare extension part for securing a deformation stroke thereof.

With such arrangements, if the door is pushed upward by the force of the inflating airbag, the hinge, which is less rigid than the door, is plastically deformed to allow the unfolding of the door. Furthermore, the deformation-stroke-securing deformable portion as the spare extension part extends in response to the unfolding of the door, whereby the door is smoothly unfolded to be reversed onto the outer hood panel about the hinge. This makes it possible, when the airbag is inflated, to sufficiently unfold the door and open the opening so that the door is supported by the hinge.

Preferably, the connector member is attached to a reinforcement, which is fixed to the inner hood panel and which connects the inner hood panel with the outer hood panel and reinforces the hood.

Because the connector member is attached to a reinforcement, which is fixed to the inner hood panel and adapted to reinforce the hood and to connect the inner hood panel with the outer hood panel, the hinge can be held in place more stably while the door is unfolded by the force of the inflating airbag, which makes the unfolding of the door more stable.

Preferably, the hinge has a reinforced tip end portion that is connected to the connector member.

Because the hinge has the reinforced tip end portion connected to the connector member, when the door is pushed upward by the force of the inflating airbag and the tip end portion of the hinge is held in place by the connector member, the holding state can be kept stable, which allows the door to unfold more stably.

Preferably, the connector member also includes a stepped bolt, which allows the hinge to be relatively displaced within the predetermined limit in an up-down direction and the longitudinal direction of the vehicle.

Because the connector member is the stepped bolt that allows the hinge to be relatively displaced within the predetermined limit in the up-down direction and the longitudinal direction of a motor vehicle, when the door is attached to the inner hood panel to cover up the opening of the outer hood panel, the hinge can be properly displaced relative to the stepped bolt in the longitudinal direction and then up-down direction of the vehicle and hence can accommodate any dimensional deviation between the opening and the door. This facilitates the unfolding operation of the door.

### BRIEF DESCRIPTION OF THE DRAWINGS

The above and other objects and features of the present invention will become apparent from the following description of a preferred embodiment, given in conjunction with the accompanying drawings, in which:

FIG. 1 is a cross-sectional view of a hood airbag device in accordance with a preferred embodiment of the present invention when the airbag is not deployed, which is taken along a line passing through a hinge in a longitudinal direction of a vehicle;

FIG. 2A is an enlarged cross-sectional view of a tip end portion of the hinge connected to a stepped bolt and FIG. 2B is an enlarged cross-sectional view of the hinge relatively displaced in a direction of the arrow “U” with respect to the stepped bolt;

FIG. 3 is a cross-sectional view of the hood airbag device in accordance with the present invention, which is taken along a line passing through a clip in a longitudinal direction of a vehicle;

FIG. 4 is a cross-sectional view depicting the clip separated from an outer hood panel in the hood airbag device; and

FIG. 5 is a cross-sectional view illustrating the clip separated from the outer hood panel, the hinge relatively displaced with respect to the stepped bolt, and a deformable portion of the hinge extended away from the stepped bolt.

### DETAILED DESCRIPTION OF THE INVENTION

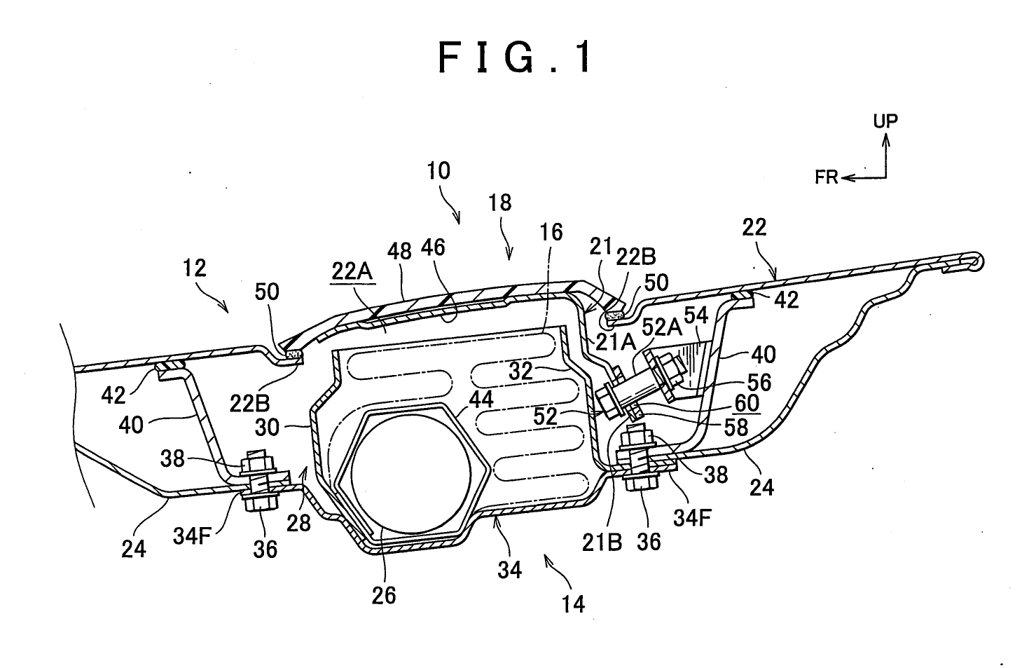

Hereinafter, there will be described a preferred embodiment of the present invention with reference to the accompanying drawings. Referring to FIG. 1, a hood airbag device 10 in accordance with the preferred embodiment of the present invention is provided in, e.g., a front hood 12 of a vehicle and includes an airbag 16, a door 18 and a hinge 21.

The airbag 16 is disposed between an outer hood panel 22 and an inner hood panel 24 of a hood 12 and may be inflated by the gas supplied from an inflator 26 and then deployed outside the hood 12 through an opening 22A of the outer hood panel 22. Furthermore, the airbag 16 and the inflator 26 are accommodated within a module case to form an airbag module 14.

The module case 28 is a box-like member opened toward the opening 22A of the outer hood panel 22 and extends in a width direction of the vehicle. More specifically, the module case 28 is formed into a box-like shape by, e.g., welding a front-side wall member 30, a rear-side wall member 32 and a bottom member 34 together. The bottom member 34 is provided with flange portions 34F respectively extending in a frontward direction of the vehicle from the front-side wall member 30 and in a rearward direction of the vehicle from the rear-side wall member 32. The flange portions 34F of the module case 28 in the airbag module 14 are assembled and fastened to the inner hood panel 24 together with the reinforcement 40 by means of bolts 36 and nuts 38.

The reinforcement 40 is of an inverted hat shape in cross-section and extends in the vehicle width direction between the outer hood panel 22 and the inner hood panel 24. Furthermore, the reinforcement 40 is directly coupled to the inner hood panel 24 and supports the outer hood panel 22 through, e.g., a mastic 42.

The inflator 26 accommodated within the module case 28 supplies gas to inflate the airbag 16 when an impact object (not shown) collides against the frontal area of the vehicle. The inflator 26 is fixedly secured by means of, e.g., a mounting bracket 44, to the bottom member 34 of the module case 28 in vicinity of the front-side wall member 30.

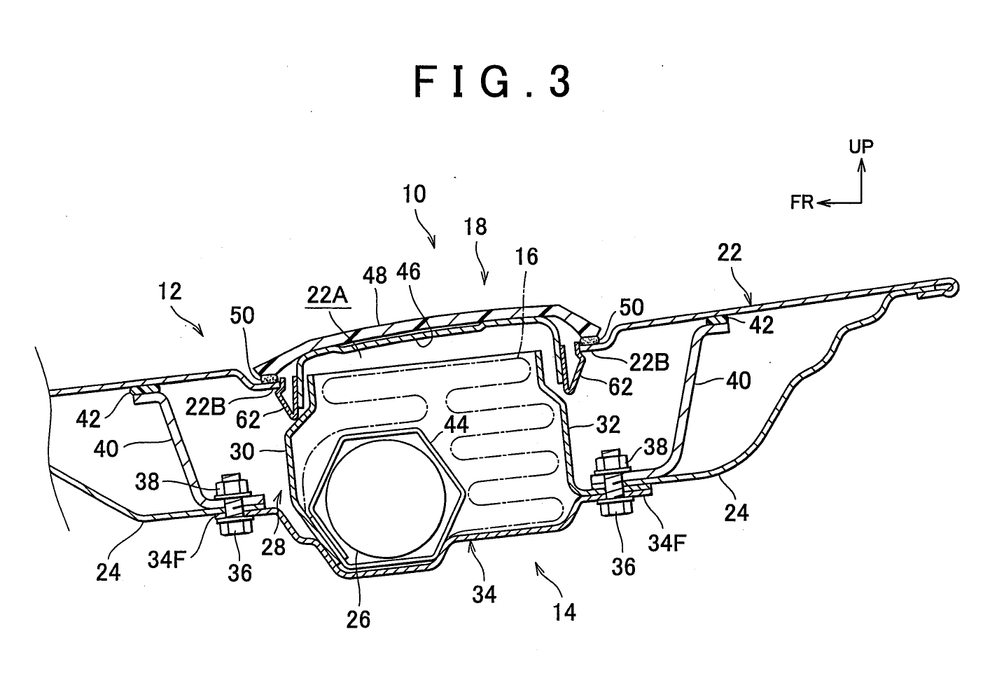

The door 18 normally covers or closes the opening 22A formed in the outer hood panel 22 and can be unfolded by the force of the inflating airbag 16 when it is inflated to thereby open the opening 22A. The door 18 includes a doorframe 46 formed by shaping, e.g., an aluminum plate, and a synthetic resin cover 48 fixed on the doorframe 46. As illustrated in FIG. 3, the door 18 is securely engaged with the peripheral portion 22B around the opening 22A of the outer hood panel 22 by means of a plurality of clips 62 that can be elastically deformed so that it can be detached from the outer hood panel 22. The door 18 is retained in a position where it covers the opening 22A. A sealing member 50 is interposed between the cover 48 of the door 18 and the peripheral portion 22B around the opening 22A of the outer hood panel 22. The clips 62 are affixed to, e.g., the doorframe 46, and are made to be elastically deformed to be detached from the peripheral portion 22B around the opening 22A at the moment when the force of the inflating airbag 16 is exerted on the door 18.

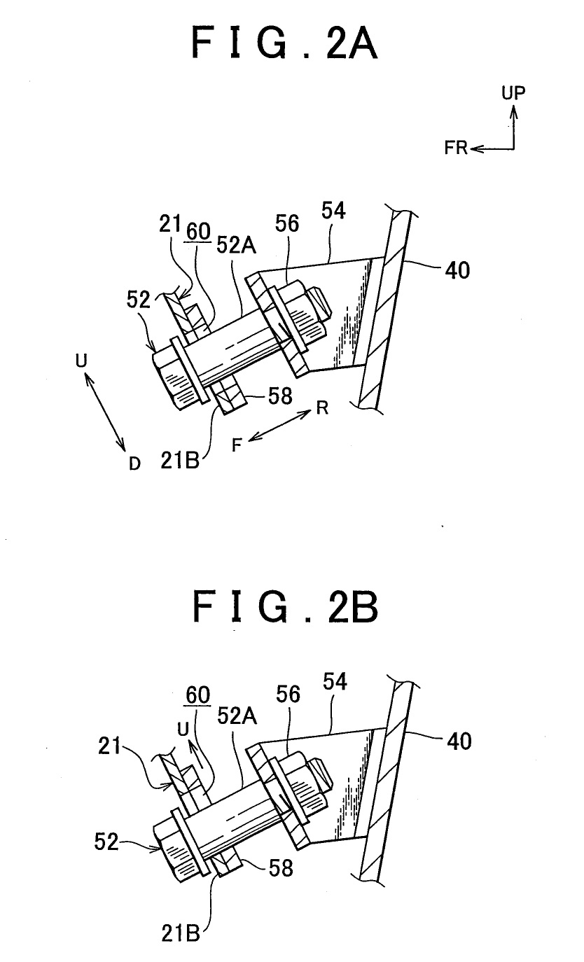

Referring to FIG. 1, the hinge 21 is connected to a stepped bolt 52, which is an exemplary connector member to the inner hood panel 24, in such a manner that it can be relatively displaced within a predetermined limit with respect to the inner hood panel 24. The hinge 21 supports the door 18 when the door is opened. A plurality of hinges 21 may be provided at the rear edge of the doorframe 46 of the door 18, for example, along the length of the door 18. As shown in FIG. 2A, the hinge 21 has a tip end portion 21B, connected to the stepped bolt 52, that is reinforced by a reinforcing member 58. Furthermore, both the tip end portion 21B and the reinforcing member 58 have a through-hole 60 through which a span 52A of the stepped bolt 52 extends, with a gap left therebetween.

As shown in FIG. 1, the stepped bolt 52 is disposed so that an axis of the stepped bolt 52 inclines against horizontal plane. That is, a front surface of a mounting bracket 54 inclines such that a top end of the front surface of the mounting bracket 54 is disposed forward of a bottom end of the front surface of the mounting bracket 54, and the stepped bolt 52 is fastened to the inclined front surface of the mounting bracket 54. Therefore, the axis of the stepped bolt 52 inclines so that its forward portion is below its rearward portion. The stepped bolt 52 is fastened by means of a nut 56 to the mounting bracket 54, which is fixedly secured to the reinforcement 40. Referring to FIG. 2A, the stepped bolt 52 has the span 52A that allows the hinge 21 to be relatively displaced within a predetermined limit in an up-down direction and the longitudinal direction of the vehicle, namely in the directions of the arrows “U” and “D” and in the directions of the arrows “F” and “R”.

The through-hole 60 provided in the tip end portion 21B of the hinge 21 has an elongated shape extending, e.g., in the directions of the arrows U and D to allow the hinge 21 to make relative displacement at least in the substantially up and down direction of the vehicle. By designing the through-hole 60 to have an increased length, the gap between the tip end portion 21B and the span 52A can be increased, thereby making it possible to extend the range in which the hinge 21 is relatively displaced in the upward direction of the vehicle with respect to the stepped bolt 52. Accordingly, if the shape of the through-hole 60 is properly set, it becomes possible to allow the clips 62 to be detached from the outer hood panel 22 within the range in which the hinge 21 is relatively displaced in the upward direction of the vehicle with respect to the stepped bolt 52. The shape of the through-hole 60 is not limited to the above, and may, for example, have an increased size in the vehicle width direction to permit relative displacement of the hinge 21 in the vehicle width direction.

Moreover, as shown in FIG. 1, the hinge 21 is integrally formed with, e.g., the rear end of the doorframe 46 of the door 18, and is less rigid than the doorframe 46 of the door 18 so that the hinge 21 can be plastically deformed with ease in response to the opening of the door 18. In addition, the hinge 21 has a deformable portion 21A as a spare extension part for securing a deformation stroke thereof. The deformable portion 21A is made extensible by bending the low rigidity portion of the hinge 21 and is extended as the door 18 is unfolded. It should be appreciated that the bent shape and the extension amount of the deformable portion 21A are not restricted to the ones illustrated in the drawings.

In the following, description will be given to an operation of the hood airbag device configured as above. The structure of the airbag device before deployment will first be described with reference to FIGS. 1 and 2A. In the hood airbag device 10, the hinge 21 for supporting the unfolding of the door 18 is connected to the stepped bolt 52 at the side of the inner hood panel 24 in a floating condition and can be relatively displaced within a predetermined range, namely, within the gap between the span 52A and the through-hole 60 and within the length of the span 52A. Accordingly, when the door 18 is attached to the inner hood panel 24 to cover the opening 22A of the outer hood panel 22, the hinge 21 can make relative displacement with respect to the stepped bolt 52 in the directions of the arrows F and R and in the directions of the arrows U and D and thus can accommodate any dimensional deviation between the opening 22A and the door 18.

Since the door 18 is not a sub-assembly of the airbag module 14 that includes the airbag 16 and the inflator 26, there is no need to take into account the dimensional deviation in sub-assembling the airbag module 14. This makes it possible to maintain the design integrity of the opening 22A of the outer hood panel 22 and that of the door 18 provided on the opening 22A, thus improving the external appearance of the vehicle. Because the door 18 is separated from the airbag module 14, it is possible to reduce the vertical movement of the door 18 due to the vertical vibration of the vehicle as compared with a case where the door 18 is combined with the airbag module 14. This makes it possible to suppress the floating movement of the door 18 as a countermeasure for the vertical vibration.

Furthermore, as illustrated in FIG. 3, the door 18 of the hood airbag device 10 is held in place by the clips 62 at a position where the door 18 covers the opening 22A of the outer hood panel 22. The clips 62 are configured such that they can be elastically deformed and can be separated from the outer hood panel 22, so that the opening 22A remains stably covered by the door 18 when the airbag is not deployed. Thus, it is possible to maintain the design integrity of the opening 22A and that of the door 18 when the airbag is not deployed while the airbag is stored.

Next, the operation of the vehicle airbag device 10 when an impact object collides against the frontal area of the vehicle will be described. Referring to FIG. 1, upon collision of the impact object, the inflator 26 of the hood airbag device 10 is actuated to supply a large quantity of gas into the airbag 16, which is accommodated within the module case 28 in a collapsed state. In response, the airbag 16 begins to be inflated and the door 18 is unfolded by the force of its inflation. Then, the airbag 16 is deployed outside the hood 12 and makes contact with the impact object to absorb the shock.

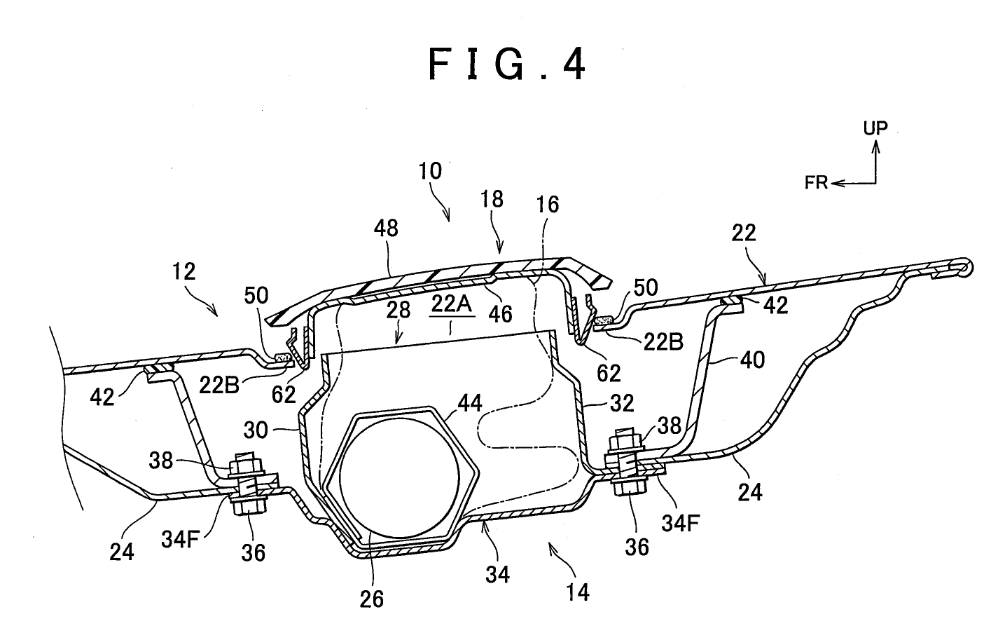

More specifically, as can be seen in FIG. 4, the force of the inflation is exerted on the door 18 as the airbag 16 is inflated. The door 18 is pushed upward by the force of the inflating airbag 16, and the clips 62 are elastically deformed and detached from the outer hood panel 22, as a result of which the door 18 is allowed to unfold. At this time, the hinge 21 can be displaced relative to the stepped bolt 52 in the direction of the arrow U until the lower end of the through-hole 60 reaches the stepped bolt 52 as illustrated in FIG. 2A. At the position where the lower end of the through-hole 60 rests against the stepped bolt 52, the tip end portion 21B of the hinge 21 is held in place by the stepped bolt 52. The tip end portion 21B of the hinge 21 is reinforced by the reinforcing member 58 and the stepped bolt 52 is affixed to the reinforcement 40, so that the holding condition of the tip end portion 21B is sustained stably by the stepped bolt 52.

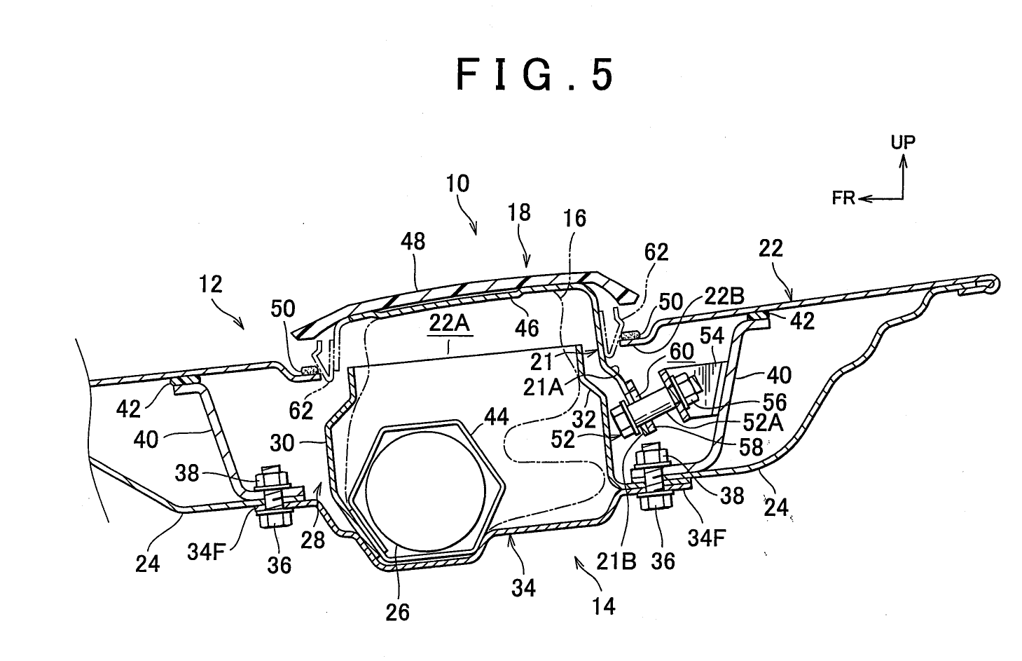

By properly setting the range of relative displacement of the hinge 21, the clips 62 can be detached away from the outer hood panel 22 within the relative displacement limit. Thus, the presence of the hinge 21 does not hinder the detachment of the clips 62, which ensures that the clips 62 are smoothly separated from the outer hood panel 22 (see FIG. 5).

As the door 18 is pushed upward by the force of the inflating airbag 16, the hinge 21, which is less rigid than the door 18, is plastically deformed to stably support the unfolding of the door 18. Furthermore, the deformation-stroke-securing deformable portion 21A as the spare extension part is extended in response to the unfolding of the door 18. This allows the door 18 to be reversed onto the outer hood panel 22 about the hinge 21, after the door 18 has been pushed upward with all of the clips 62 separated from the outer hood panel 22. Further, since the clips 62 are detached in a reliable manner, the door 18 can be unfolded smoothly (the unfolded state of the door 18 is not shown in the drawings). Once the door 18 is unfolded to thereby open the opening 22A, the airbag 16 is deployed on the outside of the hood 12 through the opening 22A.

Although the stepped bolt 52 is taken as one example of connector members in the aforementioned embodiment, the connector members are not limited to the stepped bolt 52 and any connector member may be used as far as the hinge 21 can be connected thereto in a floating condition. Likewise, the door 18 is not restricted to the aforementioned one formed by fixing the cover 48 to the doorframe 46. For example, the doorframe 46 itself may cover the opening 22A of the outer hood panel 22 without using the cover 48.

While the invention has been shown and described with respect to the preferred embodiments, it will be understood by those skilled in the art that various changes and modification may be made without departing from the scope of the invention as defined in the following claims.

1. A hood airbag device for use in a vehicle, comprising:
an airbag, disposed between an outer hood panel and an inner hood panel of a hood, that is deployed through an opening of the outer hood panel by a gas supplied from an inflator;
a door, which covers the opening when the airbag is not deployed, that is unfolded and opened by when the airbag inflates upon deployment; and
a hinge connected to a connector member on the side of the inner hood panel in such a manner that the hinge is relatively displaceable within a predetermined range with respect to the inner hood panel.

2. The hood airbag device according to claim 1, wherein the door is retained by a plurality of clips in a position where the door covers the opening, each of the clips being elastically deformable to be detached from the outer hood panel.

3. The hood airbag device according to claim 2, wherein the relatively displaceable limit of the hinge is set in such a manner as to allow the clips to be detached from the outer hood panel.

4. The hood airbag device according to claim 1, wherein the hinge is less rigid than the door so that the hinge is plastically deformable with ease in response to the unfolding of the door, the hinge provided with a deformable portion as a spare extension part for securing a deformation stroke thereof.

5. The hood airbag device according to claim 1, wherein the connector member is attached to a reinforcement which is fixed to the inner hood panel which connects the inner hood panel with the outer hood panel and reinforces the hood.

6. The hood airbag device according to claim 1, wherein the hinge has a reinforced tip end portion that is connected to the connector member.

7. The hood airbag device according to claim 1, wherein the connector member includes a stepped bolt that allows the hinge to be relatively displaced within the predetermined range in an up-down direction and the longitudinal direction of the vehicle.

8. The hood airbag device according to claim 7, wherein the tip end portion of the hinge have a through-hole through which the stepped bolt extends, with a gap left between the tip end portion and the stepped bolt.

9. The hood airbag device according to claim 8, wherein the through-hole has an elongated shape to allow the hinge to make relative displacement at least in the substantially up and down direction of the vehicle.

10. The hood airbag device according to claim 7, wherein the stepped bolt is disposed so that an axis of the stepped bolt inclines against horizontal plane, the forward of the axis being below the rearward of the axis.
